(19) United States
(12) Patent Application Publication
(10) Pub. No.: US 2015/0081414 A1
(43) Pub. Date: Mar. 19, 2015

(54) LOTTERY PROMOTION

(71) Applicant: TMS GLOBAL SERVICES PTY LTD, BRISBANE, QUEENSLAND (AU)

(72) Inventors: Mike Veverka, Mount Ommaney (AU); Brad Board, Kenmore (AU)

(21) Appl. No.: 14/387,574

(22) PCT Filed: Feb. 14, 2013
(86) PCT No.: PCT/AU2013/000124

§ 371 Date: Sep. 24, 2014

(30) Foreign Application Priority Data
Apr. 18, 2012 (AU) 2012901530

(51) Int. Cl. G06Q 30/02

(52) U.S. Cl. CPC G06Q 30/0224; G06Q 30/0255
USPC 705/14.25; 705/14.53

(57) ABSTRACT

The present invention relates to a lottery promotional method. The method involves the step of receiving, with a server, confirmation of a ticket purchaser being at a geographic location to qualify for a promotional offer offered in conjunction with a lottery ticket purchase. The geographic location may include either a display or a reseller store. The server may receive a QR code to qualify for the promotional offer.

### TECHNICAL FIELD

The present invention relates to lottery promotion techniques.

### BACKGROUND

The reference to any prior art in this specification is not, and should not be taken as an acknowledgement or any form of suggestion that the prior art forms part of the common general knowledge.

Newsagents, convenience stores and gas stations traditionally sell lottery tickets on behalf of lottery providers such as the New York Lottery, the Tatts Group etc. These resellers only receive a small commission for the sale of each ticket and further rely upon sales of other items (e.g. newspapers, drinks, etc.). In recent times, many lottery players have taken to purchasing their lottery tickets via the Internet which has adversely affected the revenue of resellers from not only the tickets themselves but other items.

Physical means of promoting lotteries such as posters, billboards, digital signs and other forms of physical advertising are an opportunity to remind and stimulate lottery players about promotions and upcoming draws.

Embodiments of the present invention provide for increased patronage of resellers by lottery players.

Embodiments of the present invention utilize physical advertising in high traffic areas to promote lottery play.

### SUMMARY OF THE INVENTION

According to one aspect of the present invention, there is provided a lottery promotional method involving the step of:

receiving, with a server, confirmation of a ticket purchaser being at a geographic location to qualify for a promotional offer offered in conjunction with a lottery ticket purchase.

The geographic location may be a display, and the confirmation may be received responsive to scanning or reading the display. Alternatively, the geographic location may be a reseller store.

The foregoing step of receiving may involve receiving, with the server, a code to qualify for the promotional offer.

In one embodiment, the code is received subsequent to the lottery ticket purchase. The code may be received from a store at the geographic location. The code may be received from a computer or a mobile internet device in or around the store. The code may be scanned.

In an alternative embodiment, the code is received prior to the lottery ticket purchase. The code may be received subsequent to capturing or reading from the display. The method may involve enabling online purchasing of the ticket responsive to receiving the code.

The method may further involve the step of establishing the promotional offer. The step of establishing may involve linking the promotional offer with the lottery ticket purchase.

The method may further involve the step of enabling the lottery ticket purchase. The lottery ticket purchase may be an online purchase. The lottery ticket purchase may be associated with the code.

The method may further involve the step of allocating the promotional offer to a lottery ticket purchaser. The method may further involve the step of updating purchaser details in a database. The method may further involve the step of enabling the purchaser to check the purchaser details in the database.

According to another aspect of the present invention, there is provided a lottery promotional system including:

a server for receiving confirmation of a ticket purchaser being at a geographic location to qualify for a promotional offer offered in conjunction with a lottery ticket purchase.

According to another aspect of the present invention, there is provided a lottery promotional system including:

a server for receiving a code to qualify for a promotional offer offered in conjunction with a lottery ticket purchase.

According to another aspect of the present invention, there is provided a lottery promotional method involving the step of:

receiving, with a server, a code to qualify for a promotional offer offered in conjunction with a lottery ticket purchase.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a lottery promotional system in accordance with an embodiment of the present invention; and

FIG. 2 is a flowchart showing a lottery promotional method performed with the system of FIG. 1 and in accordance with a first embodiment of the present invention; and

FIG. 3 is a flowchart showing a lottery promotional method performed with the system of FIG. 1 and in accordance with a second embodiment of the present invention.

### DETAILED DESCRIPTION OF PREFERRED EMBODIMENTS

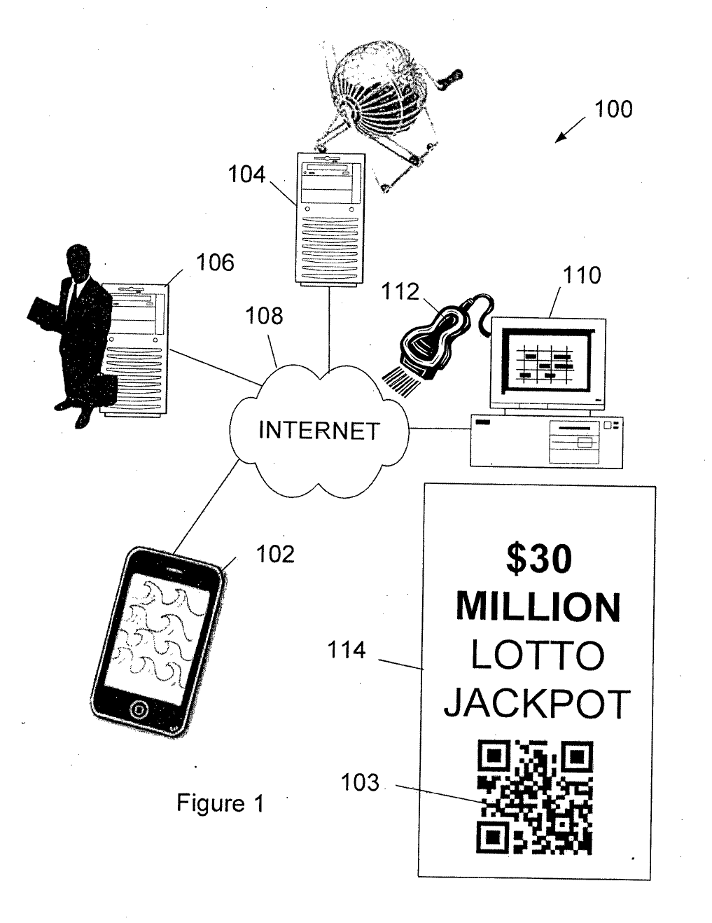

According to an embodiment of the present invention, there is provided a lottery promotional system 100 as shown in FIG. 1. The system 100 includes a mobile internet device (MID) 102 in the form of a mobile phone (e.g. iPhone, Android, etc.) or Personal Digital Assistant (PDA). The MID 102 functions as a reader for reading a Quick Response (QR) code 103 to register for a promotional offer that is offered in conjunction with a lottery ticket purchase. The promotional offer can include any one or more of a free game, second chance draw or an offer to purchase discounted lottery tickets.

The system 100 also includes a lottery server 104 administered by a lottery provider (e.g. New York Lottery, the Tatts Group, etc.) conducting a lottery. The system 100 further includes a promoter server 106 interfaced to the lottery server 104 via the Internet 108. The promoter server 106 is configured to sell tickets for the lottery online to the owner of the MID 102 and to administer the promotional offer. The promoter server 106 also includes a database for recording purchaser account details including a ticket purchase history and any allocation and redemption of the promotional offer. The database also includes a record of unique codes and corresponding associated geographic locations (e.g. code A=store A; code B=store B; etc.).

The system 100 further includes a store computer 110 located within a reseller store. The store computer includes a hand-held code reader 112 (or scanner) for reading the QR code 103 which can be present on a promotional display 114 located in or near the store.

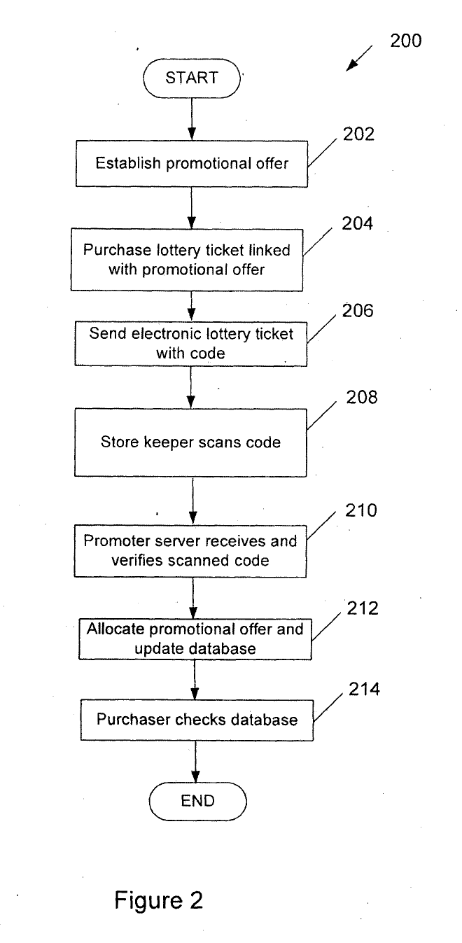

A lottery promotional method 200 in accordance with a first embodiment of the present invention, and performed with the system of FIG. 1, is now described with reference to FIG. 2.

At step 202, the promoter server 106 is used to establish the promotional offer. In particular, a promoter defines the nature of the promotional offer and links it with the lottery ticket purchase.

At step 204, the promoter server 106 completes the lottery ticket purchase for a purchaser. The purchaser may use MID 102 or a personal computer (PC) to purchase a lottery ticket over the internet 108 using a ticket purchasing website hosted by the promoter server 106.

At step 206, the promoter server 106 sends an electronic ticket to the MID 102 or PC along with a promotional QR code and details relating to the reseller (agency) store where the promotional offer can be redeemed.

At step 208, a storekeeper of the reseller store uses the scanner 112 to scan or read the QR code produced by the ticket purchaser. The QR code may be either stored electronically on the MID or on a hard copy of the electronic ticket. Advantageously, the purchaser is drawn into the reseller store to redeem the offer.

At step 210, the promoter server 106 receives the code from the store computer 110 and verifies the code so that the purchaser can be registered for the promotional offer offered in conjunction with the lottery ticket purchase. Receipt of the code serves as confirmation that the ticket purchaser is at the store (i.e. known geographic location recorded in the database) so that the ticket purchaser qualifies for the promotional offer.

At step 212, the promoter server 106 allocates the promotional offer to the purchaser and updates the database by recording purchaser details including allocation and redemption of the promotional offer.

At step 214, the purchaser can use the MID 102 to check their purchaser account details in the database of the promoter server 106.

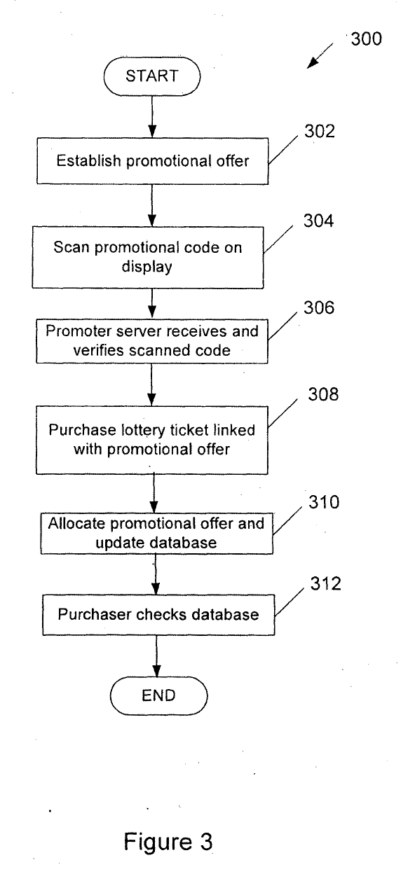

A lottery promotional method 300 in accordance with a second embodiment of the present invention, and performed with the system of FIG. 1, is now described with reference to FIG. 3.

At step 302, the promoter server 106 is used to establish the promotional offer. In particular, a promoter defines the nature of the promotional offer and links it with the lottery ticket purchase.

At step 304, the MID 102 scans or captures the QR code 103 on a promotional display 114 at a known geographic location. The display 114 can be a poster, sign, video screen or other advertisement advertising a lotto jackpot. The display 114 is typically located proximal a reseller store where the promotional offer can be redeemed.

At step 306 responsive to scanning or capturing the QR code 103, the promoter server 106 receives and verifies the code from the MID 102, and connects the purchaser's MID 102 to a ticket purchasing webpage (for the lotto jackpot draw) of a website hosted by the promoter server 106. Receipt of the code serves as confirmation that the ticket purchaser is at the display (i.e. known geographic location recorded in the database) to qualify for the promotional offer.

At step 308, the promoter server 106 completes a lottery ticket purchase in the lotto jackpot draw for the purchaser and registers the purchaser for the promotional offer offered in conjunction with the lottery ticket purchase.

At step 310, the promoter server 106 allocates the promotional offer to the purchaser and updates the database by recording purchaser details including allocation and redemption of the promotional offer. The purchaser can be required to come to the reseller store to redeem the promotional offer.

At step 312, the purchaser can use the MID 102 to check their purchaser account details in the database of the promoter server 106.

A person skilled in the art will appreciate that many embodiments and variations can be made without departing from the ambit of the present invention.

In the first embodiment above, at step 208, the storekeeper of the reseller store uses the scanner 112 to scan or read the QR code. Alternatively, the storekeeper may provide a display 114 which can be scanned by purchasers themselves with their MIDs 102. The promoter server 106 would then receive the code from the MID 102 and verify the code so that the purchaser can be registered for the promotional offer offered in conjunction with the lottery ticket purchase.

In the preferred embodiment, the promotional code was a Quick Response (QR) code. Alternatively, the code to be captured or scanned may be a bar code, code-word or other like encrypted or decrypted code. The code may be received by the promoter server 106 in one of many forms including a captured image of the code or a deciphered code.

In compliance with the statute, the invention has been described in language more or less specific to structural or methodical features. It is to be understood that the invention is not limited to specific features shown or described since the means herein described comprises preferred forms of putting the invention into effect.

The claims defining the invention are as follows:

1. A lottery promotional method involving the step of:
receiving, with a server, confirmation of a ticket purchaser being at a geographic location to qualify for a promotional offer offered in conjunction with a lottery ticket purchase.

2. A lottery promotional method as claimed in claim 1, wherein the geographic location includes a display, and the confirmation can be received responsive to scanning or reading the display.

3. A lottery promotional method as claimed in claim 1, wherein the geographic location includes a reseller store.

4. A lottery promotional method as claimed in claim 1, wherein the step of receiving involves receiving, with the server, a code to qualify for the promotional offer.

5. A lottery promotional method as claimed in claim 4, wherein the code is received subsequent to the lottery ticket purchase.

6. A lottery promotional method as claimed in claim 4, wherein the code is received from a store at the geographic location.

7. A lottery promotional method as claimed in claim 6, wherein the code is received from a computer or a mobile internet device in or around the store.

8. A lottery promotional method as claimed in claim 6, wherein the code is scanned.

9. A lottery promotional method as claimed in claim 4, wherein the code is received prior to the lottery ticket purchase.

10. A lottery promotional method as claimed in claim 9, further involving enabling online purchasing of the ticket responsive to receiving the code.

11. A lottery promotional method as claimed in claim 4, wherein the code is received subsequent to capturing or reading from a display.

12. A lottery promotional method as claimed in claim 1, further involving the step of establishing the promotional offer.

13. A lottery promotional method as claimed in claim 12, wherein the step of establishing involves linking the promotional offer with the lottery ticket purchase.

14. A lottery promotional method as claimed in claim 1, further involving the step of enabling the lottery ticket purchase.

15. A lottery promotional method as claimed in claim 14, wherein the lottery ticket purchase is an online purchase associated with a code.

16. A lottery promotional method as claimed in claim 1, further involving the step of allocating the promotional offer to a lottery ticket purchaser.

17. A lottery promotional method as claimed in claim 1, further involving the steps of:
updating purchaser details in a database; and
enabling a purchaser to check the purchaser details in the database.

18. A lottery promotional system including:
a server for receiving confirmation of a ticket purchaser being at a geographic location to qualify for a promotional offer offered in conjunction with a lottery ticket purchase.

19. A lottery promotional system including:
a server for receiving a code to qualify for a promotional offer offered in conjunction with a lottery ticket purchase.

20. A lottery promotional method involving the step of:
receiving, with a server, a code to qualify for a promotional offer offered in conjunction with a lottery ticket purchase.
